(19) United States
(12) Patent Application Publication
(10) Pub. No.: US 2011/0049195 A1
(43) Pub. Date: Mar. 3, 2011

(54) DISPENSING CLOSURE ASSEMBLIES

(76) Inventors: Allin Nicholas Russell, Auckland (NZ); James Richard Manley, Auckland (NZ); Brendan Jon Lindsay, Auckland (NZ)

(21) Appl. No.: 12/864,769

(22) PCT Filed: Apr. 15, 2010
(86) PCT No.: PCT/NZ2010/000069

§ 371 Date: Oct. 21, 2010

(30) Foreign Application Priority Data
Apr. 21, 2009 (NZ) 576433
Aug. 20, 2009 (NZ) 579209

(51) Int. Cl. B67D 3/00

(52) U.S. Cl. 222/513; 222/507; 222/514; 222/521; 222/525

(57) ABSTRACT

A dispensing closure assembly for a drink container. The assembly has an occludable nozzle able to close a dispensing path way when the nozzle is in one condition relative to an occlusion providing member of the assembly, and to open a dispensing pathway when the nozzle is in a second condition relative to the occlusion providing member. The nozzle is movable from the raised non occluded open and dispensing condition to the lowered occluded non-dispensing closed condition against a bias. The nozzle is releasably latchable in the closed condition. The release involves a rotation of one part of the assembly relative to another to allow axial movement of the nozzle.

The present invention relates to dispensing closure assemblies and related combinations, components, methods and uses.

Drink or other bottles or containers (“bottles”) frequently have a pull out member of container closing closure assembly which moves components of the assembly so as to allow a dispensing pathway for liquid or other pourable content from within a drink or other container to which the closure assembly has been fixed. Many such forms of assembly require a pulling out of a nozzle member.

Our New Zealand patent specification 555579 discloses a variant of dispensing assembly being a twist assembly reliant upon essentially three moulded components such that rotation of one component relative to another that is fitted to the container or bottle has the effect of raising and/or lowering a dispensing nozzle. An occlusion of the nozzle, provided by one component, is removed by such movement.

The present invention relates still a further alternative to such twist assemblies and particularly envisages an embodiment where it is possible simply to push close a raised dispensing nozzle so that it becomes occluded yet can be opened from that occluded position by some delatching mechanism allowing a bias to become effective.

It is a further or alternative object of the present invention to provide a “pop up” type dispensing nozzle as part of a dispensing closure assembly yet requiring some manual input to release the nozzle.

It is still a further or alternative object of the present invention to provide a dispensing closure assembly having a twist release of a latching mechanism thereafter to allow a bias to effect opening.

It is a further or alternative object to use, in a nozzled dispensing closure assembly, both an outwardly biased nozzle and a latching of the nozzle by a resilient latching member held in part to provide, when cammed, a rotational bias for latching.

It is still a further or alternative object of the present invention to provide a dispensing closure assembly of a kind having valving elements that allow ambient air to bleed into a container to which it is attached if there is a sufficient pressure differential between the outside and the inside, yet which valving mechanisms do not allow release of the liquid from within a container closed by such a dispensing closure assembly.

In an aspect the invention is a dispensing closure assembly having a dispensing nozzle able to be closed against a bias yet releasable so as to allow that bias to move it to a open and dispensing condition.

In another aspect the invention is a dispensing closure assembly of a kind having an occludable nozzle able

1) to close a dispensing path way when the nozzle is in one condition relative to an occlusion providing member or assembly, and

2) to open a dispensing pathway when the nozzle is in a second condition relative to the occlusion providing member or assembly;

wherein the nozzle is movable from the non occluded open and dispensing condition to the occluded non-dispensing closed condition against a bias;

and wherein the nozzle is releasably latchable in the closed condition.

Preferably said nozzle is releasable by a twisting of one member of the dispensing closure assembly relative to another.

Preferably said twisting is against a rotational bias.

Preferably the rotational bias is provided by a resilient latching surround of the nozzle, preferably with outstands heldpo against rotation preferably to be caused by a camming interaction with the nozzle when being closed.

Preferably said nozzle moves rectilinearly against or with the bias and such bias is distinct.

In another aspect the present invention consists in a dispensing closure assembly suitable to be engaged to a complementary container, said assembly comprising or including

a first moulded component (“first component” or “housing”) adapted to engage an outlet of a complementary container and to provide a column with an outlet from which any liquid or other content (“liquid”) of such a container can egress, the first component including a closure portion or occlusion above said outlet, said column, in part, coaxially defining part of a surrounding annular well;

a second moulded component (“second component” or “nozzle”) coaxially about said column and sitting at least partially within the annular well, the second component having a dispensing outlet capable of being closed or occluded by the closure portion or occlusion of said first component, and the second component being able to move axially with respect to the column yet be restrained from rotation relative to the first component;

a spring or other biasing member (“spring”) disposed in the well of the first component and able to bias the second component to a non-occluded raised condition with respect to the first component;

a third moulded component (“third component” or “turn top”) held captive by said first component but rotatable relative thereto,

a fourth moulded component (“fourth component” or “twist bias catch”) about the nozzle and separately engaged to each of the first and third components so as to allow rotation or twisting of the third component relative to the first component yet to provide a return bias (“twist return bias”);

wherein the forth component and nozzle have profile features for a camming interaction to rotate in part the fourth component thereby to load up a twist return bias when the nozzle, when outstanding, is pressed against its spring towards its to be latched condition;

and wherein the forth component and nozzle enables, subsequent to the camming action that loads up the twist return bias, latching of part of the nozzle by the fourth component, as it is in part return rotated by the twist return bias.

Preferably the first moulded component (by insert or inserts, or otherwise) provides for an air inbleed via the annular well at least during nozzle lowering.

Preferably the first component or housing has within the well a male or female guide or guides for complementary female or male guide(s) of the second component or nozzle. Most preferably the arrangement is mouldable male outstands which are within short female channel profiles as outstands of the nozzle (preferably at the lower end thereof).

Preferably said first component or housing is screw thread engageable to a complementary container.

Preferably the annular well is a true annular well ie, any other suitable column surrounding shape can be used, ie, without an inner and/or outer facing surface(s)

Preferably the column is substantially tubular and preferably the other perimeter of the well is substantially circular.

Preferably a plateau is defined about the annular well by said first moulded member.

Preferably that plateau is bounded by an upstanding wall.

Preferably there are plurality of (female) profiles adapted to fix against rotation bias providing outstands of said fourth component or twist bias catch.

Preferably these are profiles formed inwardly of the wall.

Preferably there are provided a plurality of upstands from the plateau to act as stops to limit rotation of the twist bias catch relative to the housing.

Preferably said fourth component or twist bias catch includes somewhat radially extending outstands to act as stops relative to upstands of the housing.

Preferably those same outstands or other outstands provide a dog or other engagement feature to assume a non rotational engagement relative to said third moulded component or turn top ie, preferably dogs engageable into recesses of the third moulded component.

Preferably, in addition to the outstand or outstands that provide the stop and/or provide dogging with respect to the turn top, there are outstands to provide the radial bias.

Preferably these radial bias providing outstands are each engaged at their distal regions against rotation relative to the housing eg, preferably in said female profiles inwardly of the wall of the housing.

Preferably the inner periphery of said fourth component or twist bias catch which is to surround the column and the nozzle includes one or more camming surfaces down to an abutment shoulder or abutment shoulders.

Preferably said abutment shoulder(s) is part of the under surface of the fourth component.

Preferably the fourth component or twist bias catch has any one or more of the features hereinafter described.

Preferably the nozzle has cammable or cam following surfaces to an abutment retention surface or each to an abutment retention surface (common or otherwise).

Preferably the camming and latching is by a mechanism substantially as herein described by reference to any one or more of the accompanying drawings and/or substantially as herein after described.

In another aspect the invention is a dispensing closure assembly having a dispensing nozzle able to be closed and held in its closed condition against a rectilinear bias yet releasable from its held condition so as to allow the rectilinear bias to move the nozzle to its open condition;

wherein a resilient latching member provides the holding of the nozzle in the held and closed condition;

and wherein the resilient latching member has hold outward extensions that provide a return bias of the remainder of the resilient latching member to its latching condition from cam rotated conditions during closure.

The present invention relates to any one or more of the components substantially as hereinafter described with or without reference to any one or more of the accompanying drawings in combination, in sub assembly or in assembly.

Preferably the arrangement is the provision of a valving insert or valving inserts into the bottom of a well forming part of a first component or housing of a kind substantially as herein before described.

In still another aspect of the invention is a dispensing closure assembly having a dispensing nozzle able to be closed and held in a closed condition against a rectilinear bias yet releasable from its held condition so as to allow the rectilinear bias to move the nozzle to an open condition;

wherein a latching member, able in its latching condition to hold the nozzle in its closed condition, is able to be cammed aside from its relaxed or more relaxed latching position by the nozzle when being closed from an open condition from when, when no longer being cammed, it can assume its nozzle latching condition.

In still a further aspect the invention consists in a dispending closure assembly having a dispensing nozzle able to be closed against a bias yet releasable so as to allow that bias to move it to an open and dispensing condition (preferably by a twist of one component relative to another);

wherein there is provided an air bleed valve communicable with the ambient air other than via the flow path for dispensable contents.

Preferably the arrangement is substantially herein described irrespective of whether or not includes any one or more of the features of other aspects of the present invention.

In other aspects the present invention consists in, in assembly or in combination, a container and a dispensing closure assembly of any aspect of the present invention.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

A preferred form of the present invention will now be described with reference to the accompanying drawings.

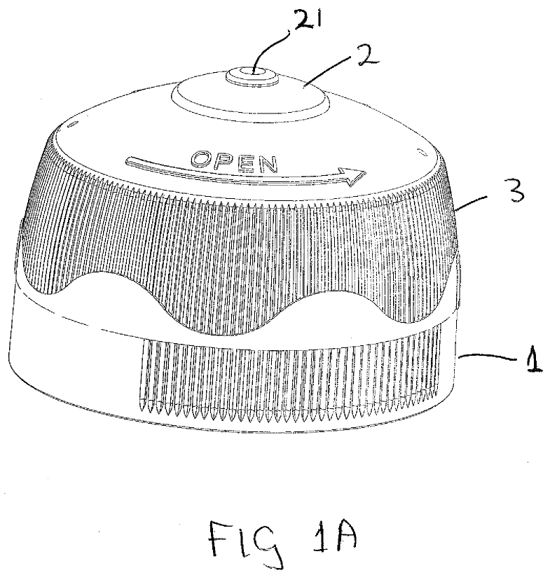

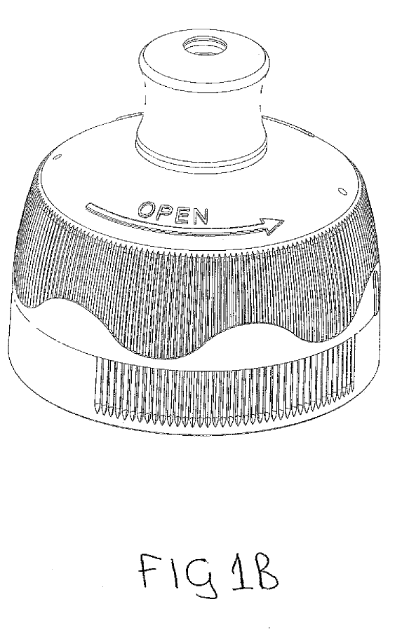

FIG. 1A is a perspective view of a first embodiment of the dispensing closure assembly from above when in the nozzle occluding condition, the nozzle being latched in its lowered or depressed condition,

FIG. 1B is a similar view to that of FIG. 1A but with the liquid flow path open, the nozzle outstanding from the twist top and the housing,

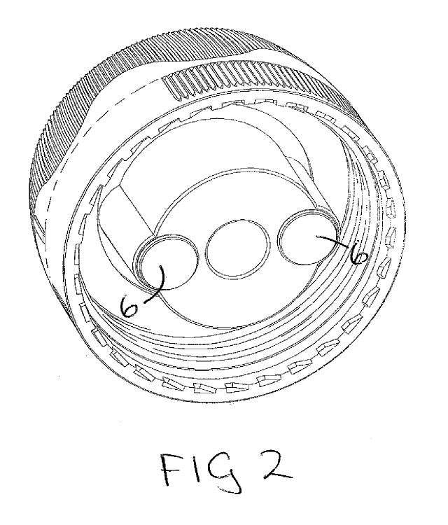

FIG. 2 is a view from below of the arrangement as shown in FIG. 1A,

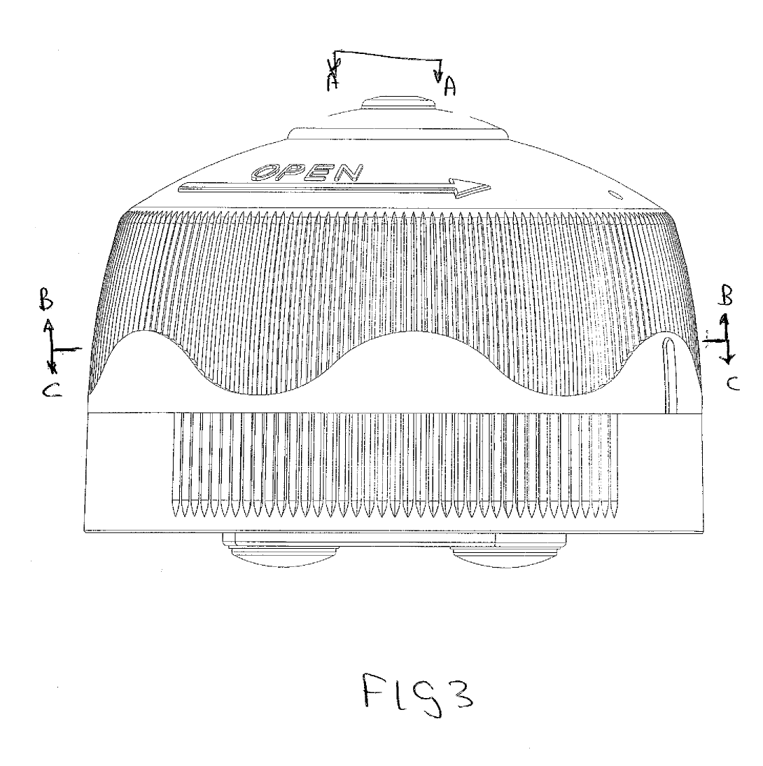

FIG. 3 is a side elevation of the arrangement as shown in FIGS. 1A and 2,

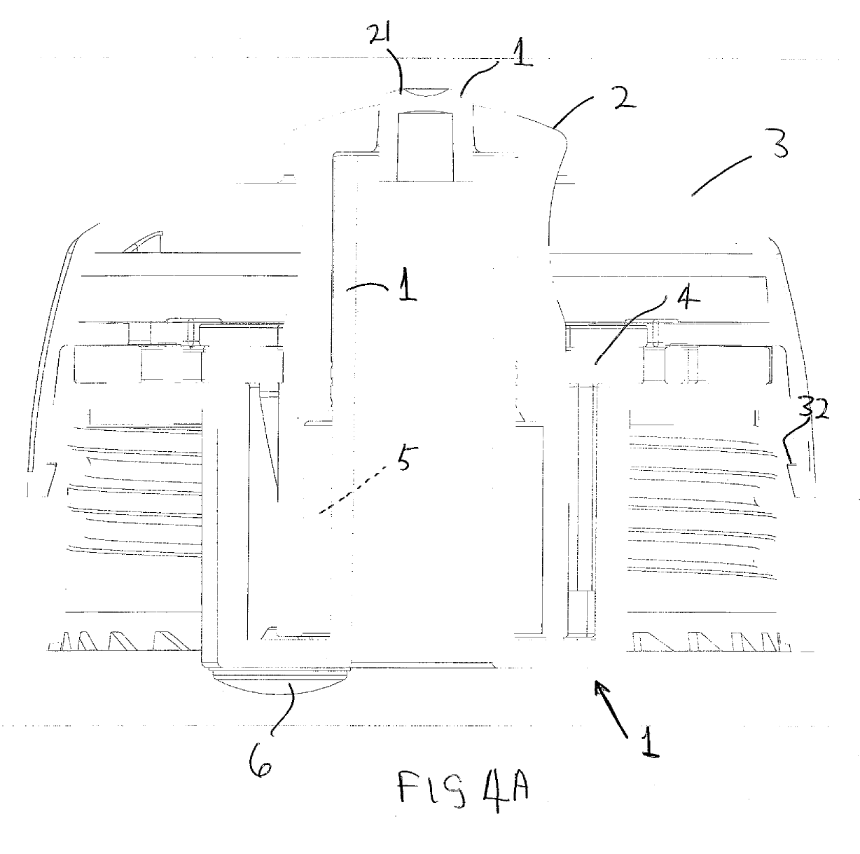

FIG. 4A is a section at AA in elevation with respect to FIG. 3, there being in that nozzle occluding condition (not shown) the depressed spring adapted to axially bias the nozzle upwardly relative to the other components when unlatched,

FIG. 4B is a similar to that of FIG. 4A but showing the nozzle upstanding and the flow path open, the flow path being shown by the arrows upwardly, a bleed down pathway being via one of preferably two inserts of the housing, the air ingress being permitted by the waisting of the nozzle near its upper end region as it is being lowered, there also being shown the spring (not shown in FIG. 4A) much as it would be if still compressed in its FIG. 4A condition,

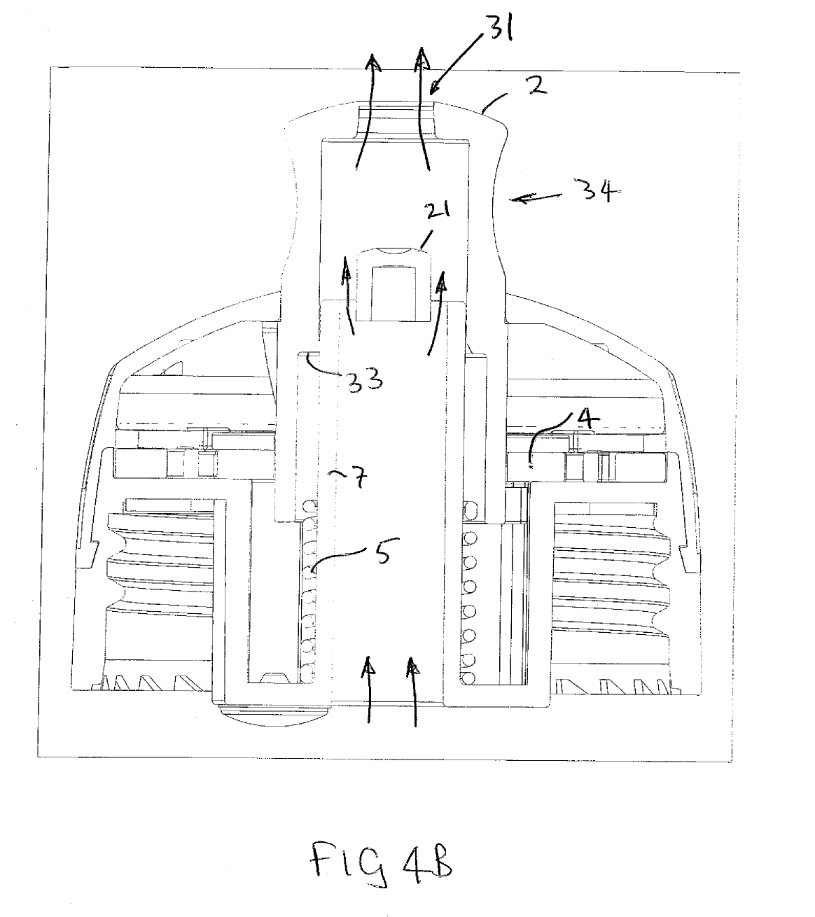

FIG. 5 is a view upwardly with respect to a Section at BB of FIG. 3,

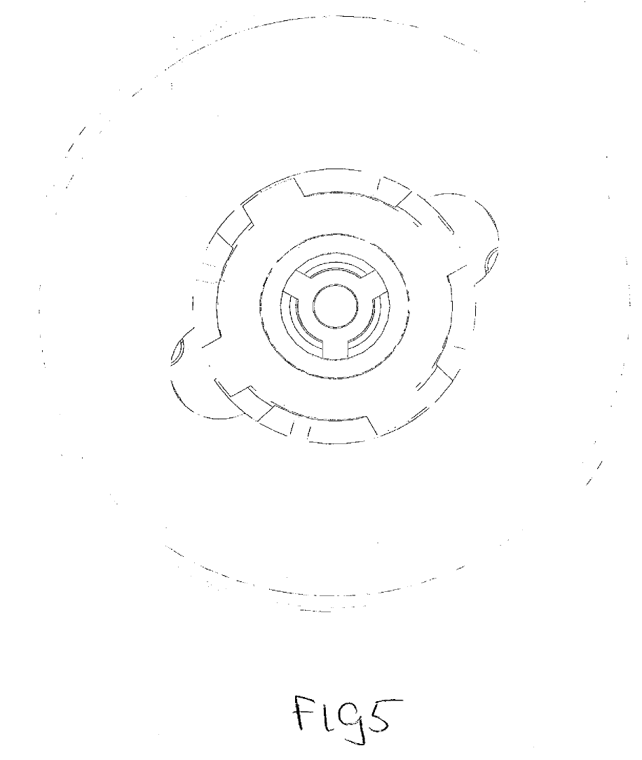

FIG. 6 is a view downwardly with respect to a Section at CC with respect to FIG. 3,

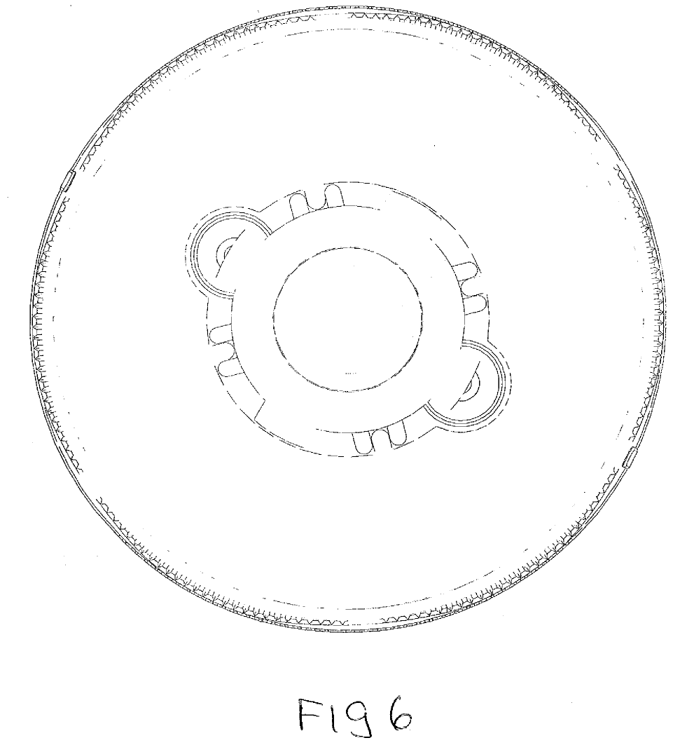

FIG. 7A is an isometric view of a section as in FIG. 4A,

FIG. 7B is a similar view to that of FIG. 7A but showing the nozzle raised,

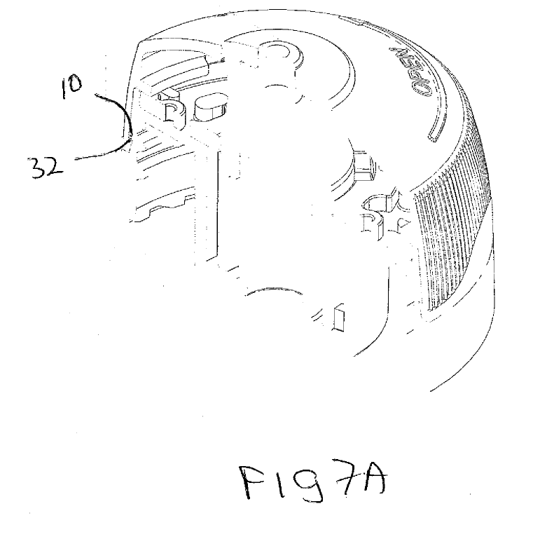

FIG. 8 is an isometric view from above of the first component or housing showing the occlusion member at the top end of the column, the annular well with vertically rising guides for the nozzle (as an anti-rotation feature) and showing a plateau with multiple profile features inwardly of a peripheral wall and/or upwardly of the plateau,

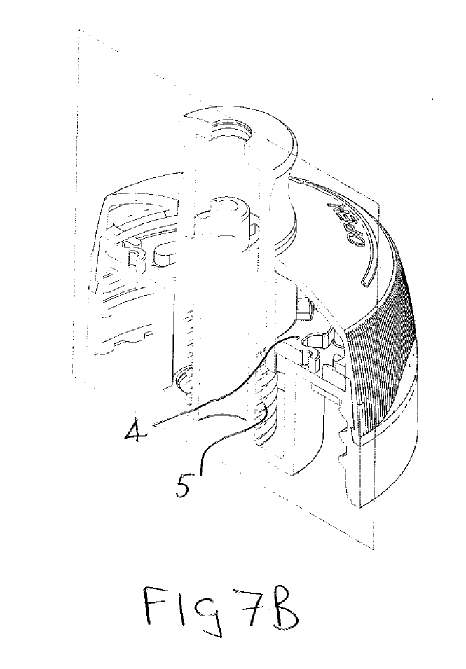

FIG. 9 is a plan view of the first component of FIG. 8,

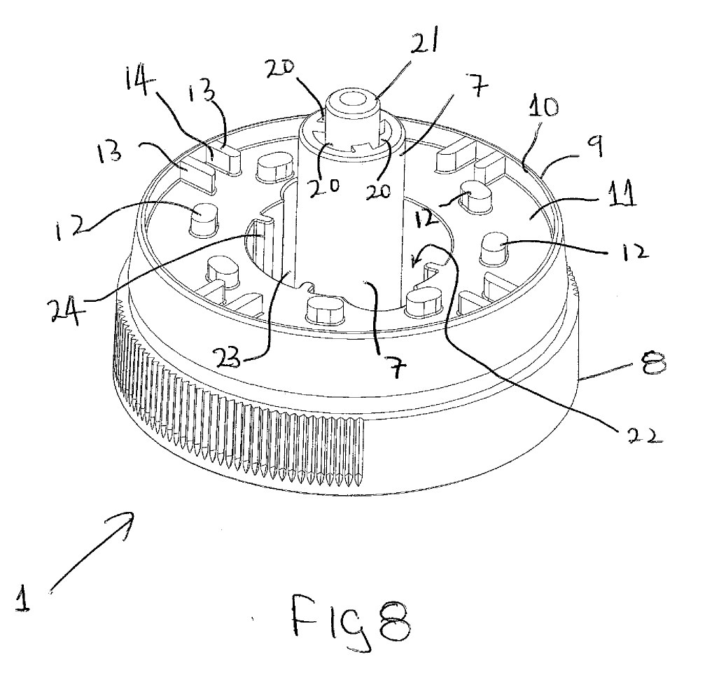

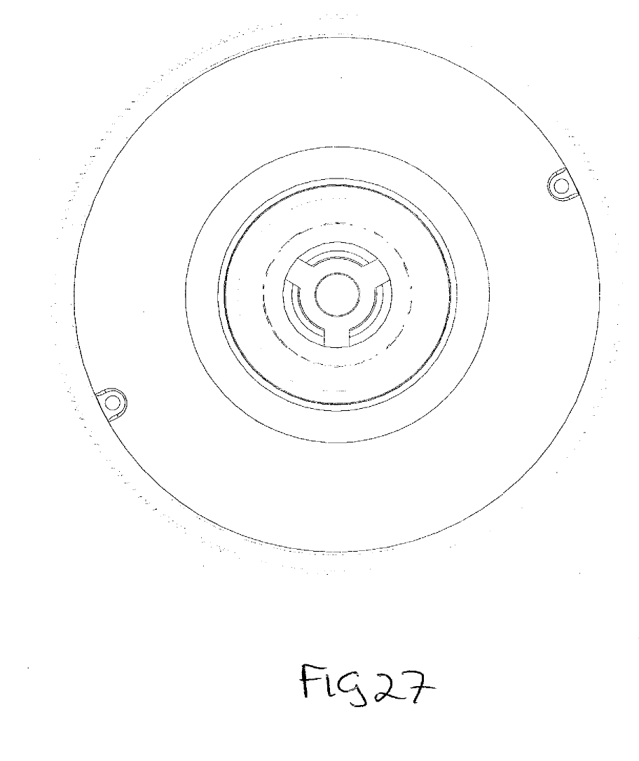

FIG. 10 is a view from below of the component of FIGS. 8 and 9 showing two openings into which valve members as disclosed in FIGS. 28 through 32 can be click-fit inserted to provide the valving pathway mentioned,

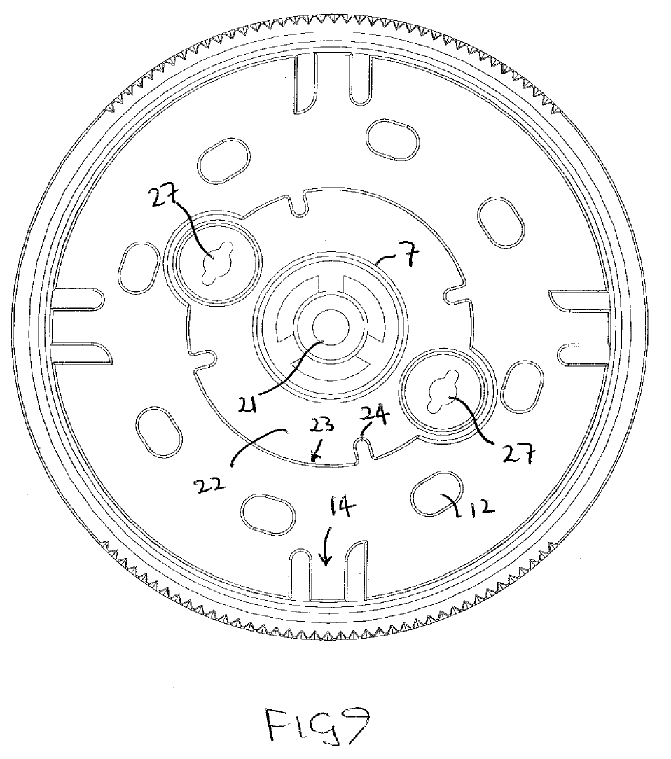

FIG. 11 is a side elevation of the first component or housing of FIGS. 8 through 10,

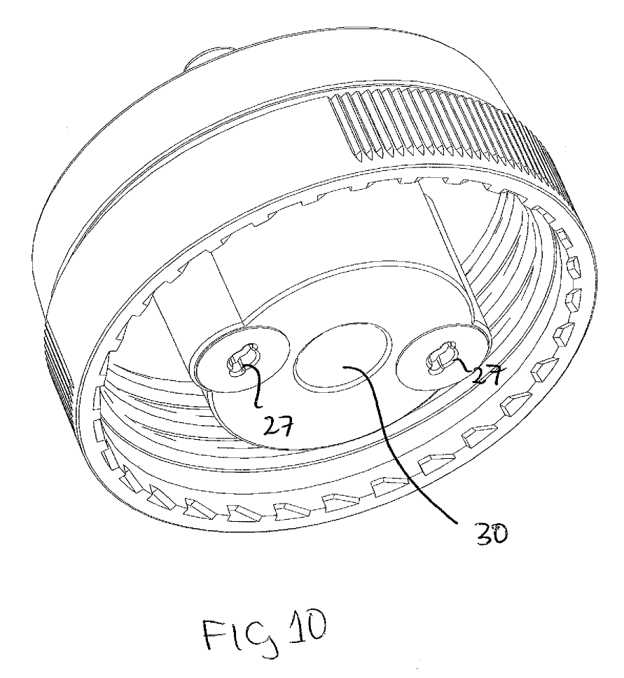

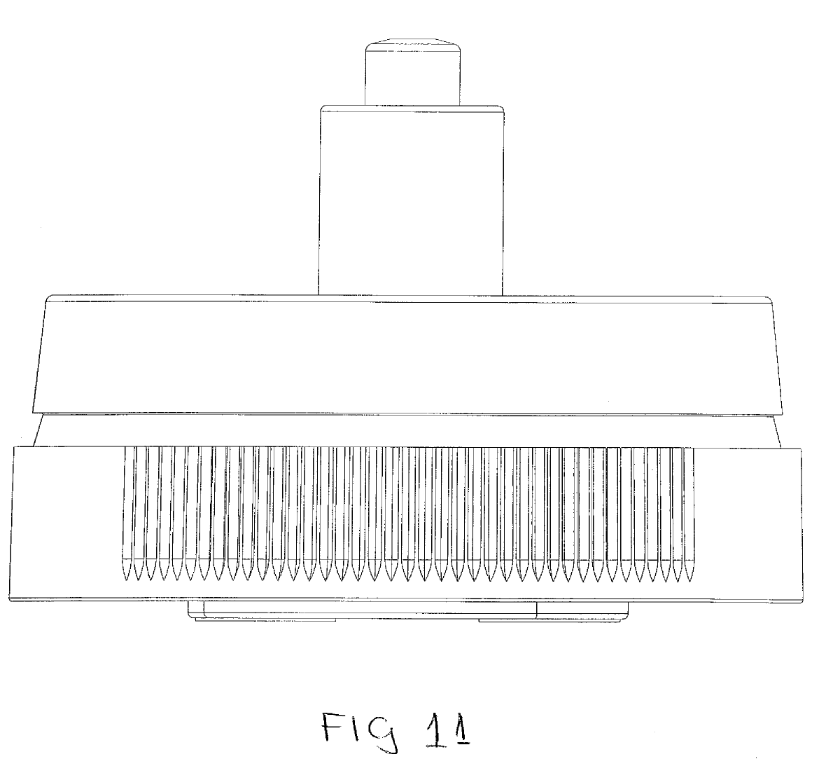

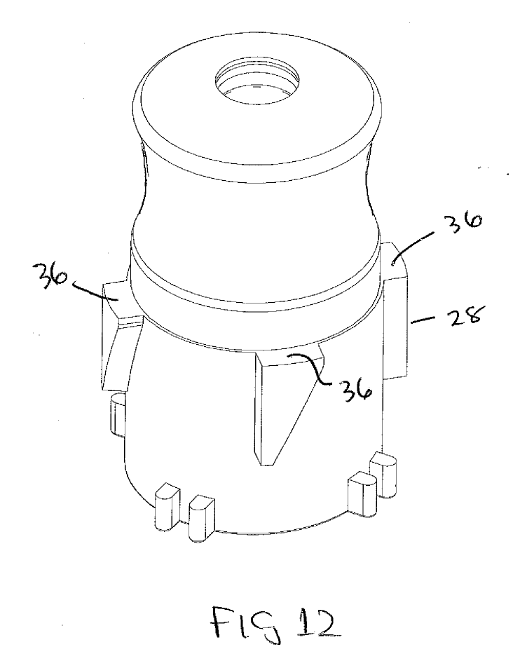

FIG. 12 is an isometric view from above of a second component or nozzle in accordance with the present invention,

FIG. 13 is an isometric view from below of the nozzle of FIG. 12,

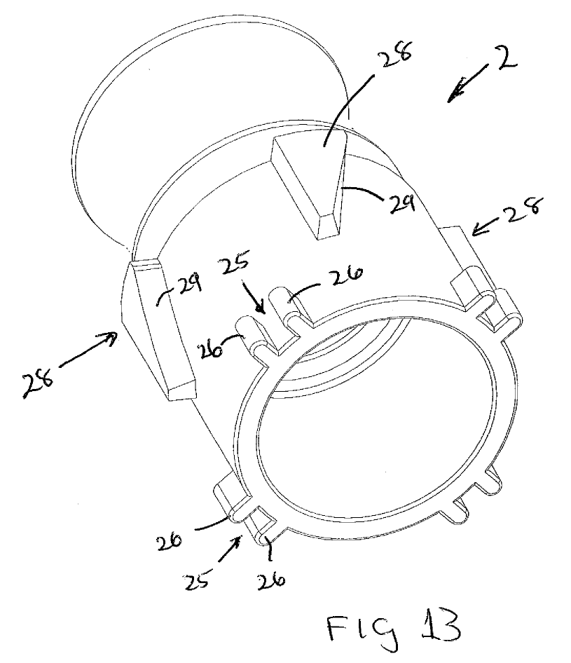

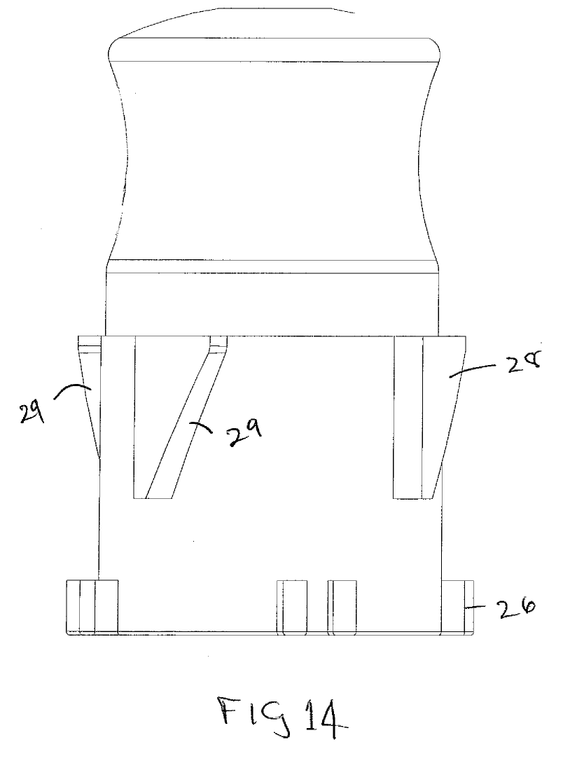

FIG. 14 is a side elevation of the nozzle of FIGS. 12 and 13,

FIG. 15 is a view from below of the nozzle of FIGS. 12 to 14,

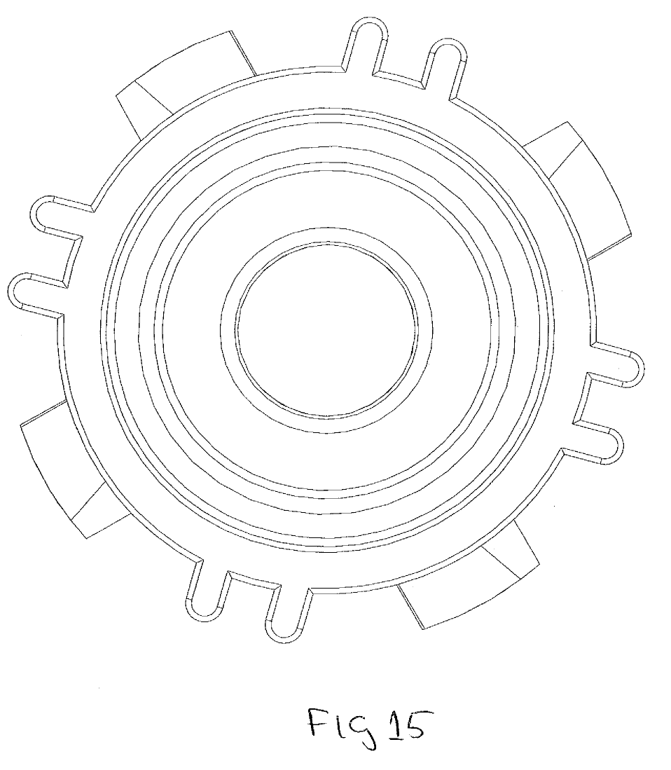

FIG. 16 is a plan view of the nozzle of FIGS. 12 to 15,

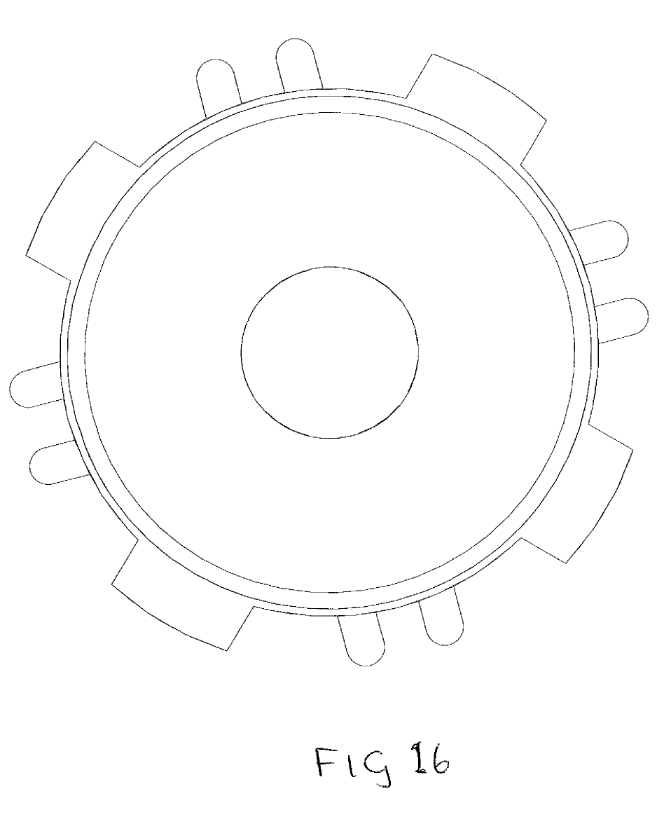

FIG. 17 is an isometric view from above the third component or turn top,

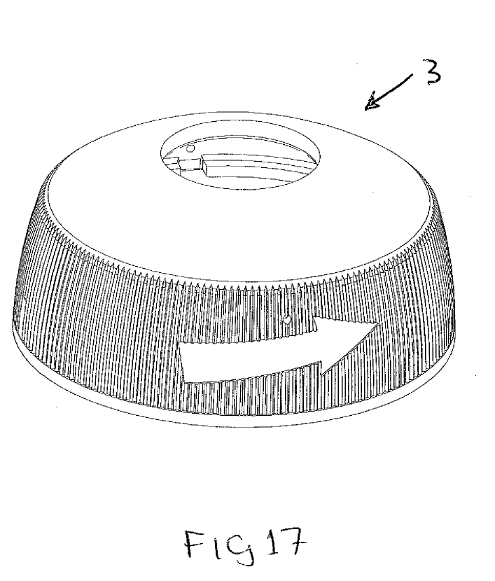

FIG. 18 is an isometric view from below of the turn top of FIG. 17 showing an inwardly directed bead to act as a catching features for the housing, and showing upwardly from that feature provision of a dog locating recess, one for each dog, of the fourth component or twist bias catch,

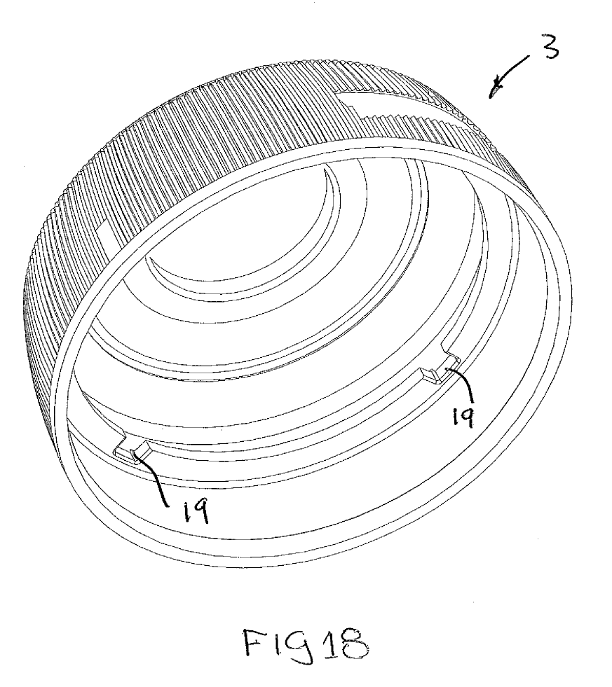

FIG. 19 is a plan view of the turn top of FIGS. 17 and 18,

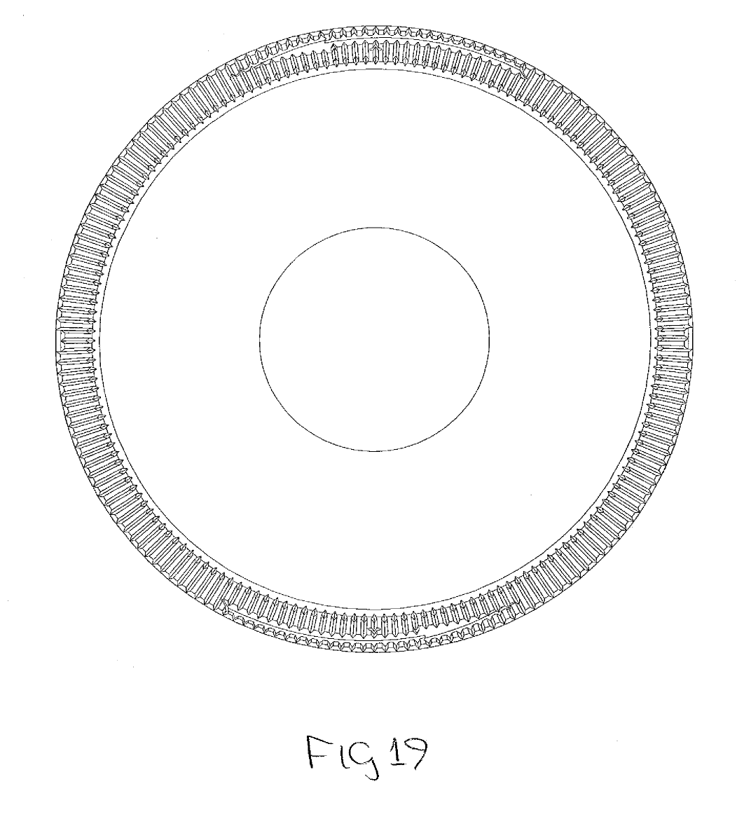

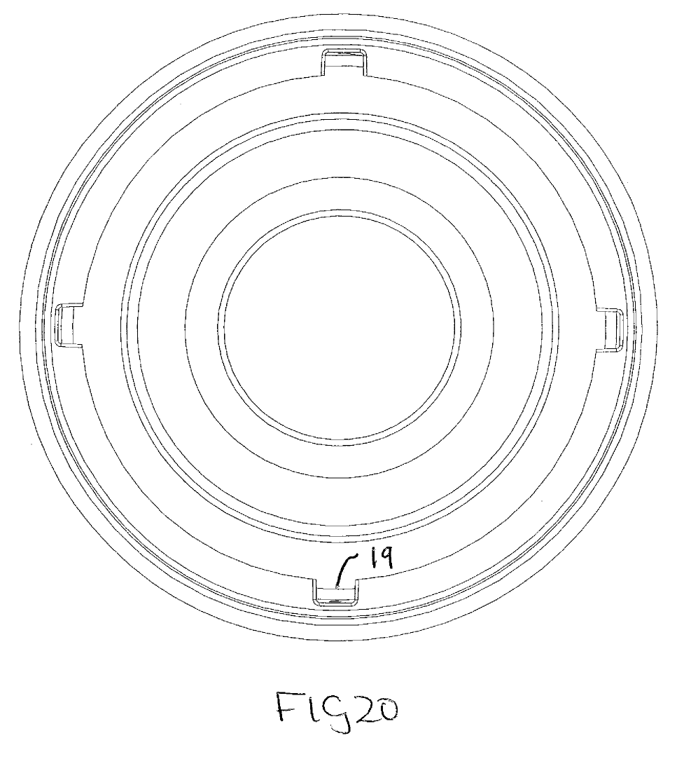

FIG. 20 is a view from below of the turn top of FIGS. 17 through 19,

FIG. 21 is a view from below of a preferred fourth component or twist bias catch, showing the interior periphery with its camming surfaces or cam following surfaces down to a shoulder (defined as a region in each case of the underlying substantially planar surface), there being two types of exterior peripheral outstands, two (or more) to be distally located by the housing as rotational bias providing members and four providing an outstand to be stopped by upstanding stops of the housing to limit rotational movement, and having in each case a dog to engage a dog receiving profile of the turn top,

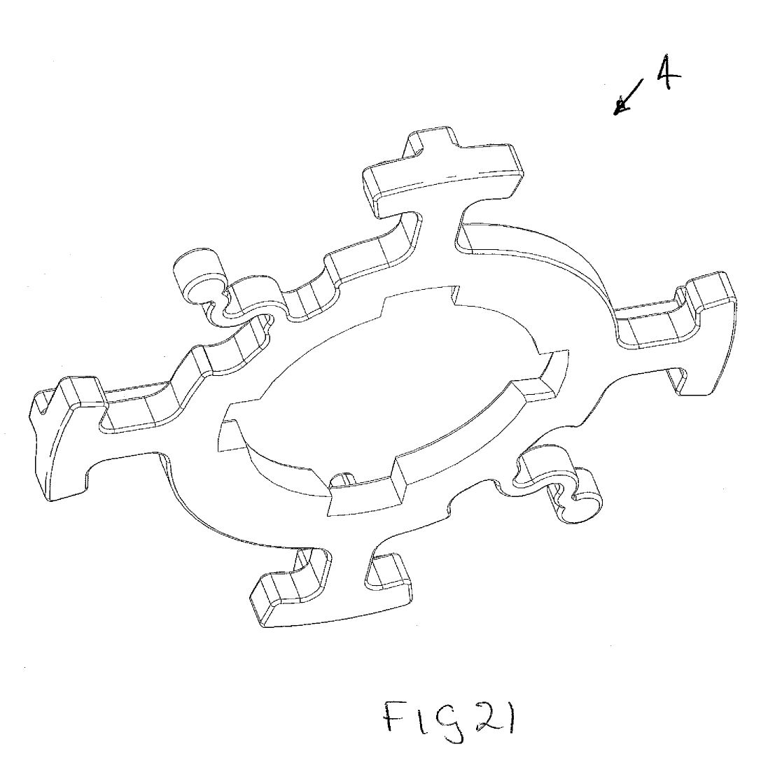

FIG. 22 is an isometric view from above of the twist bias catch of FIG. 21,

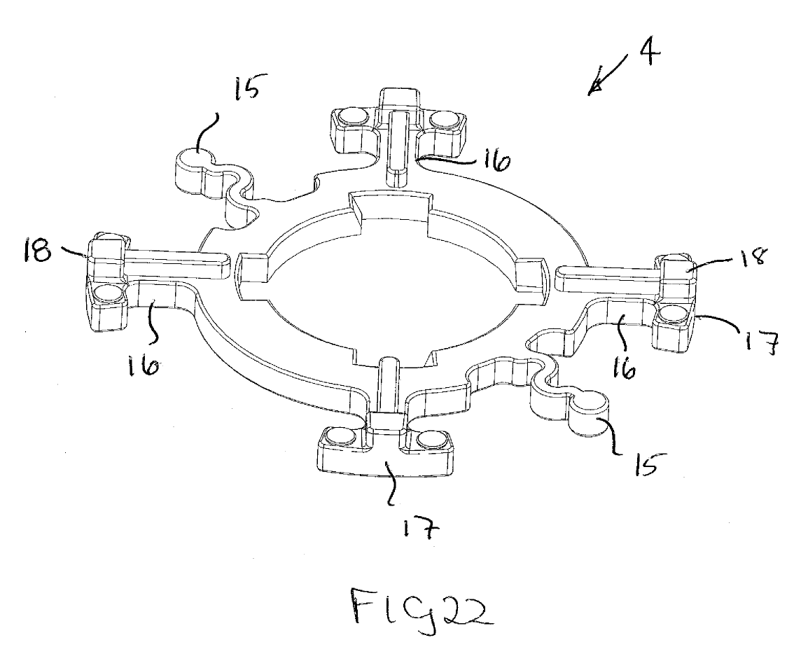

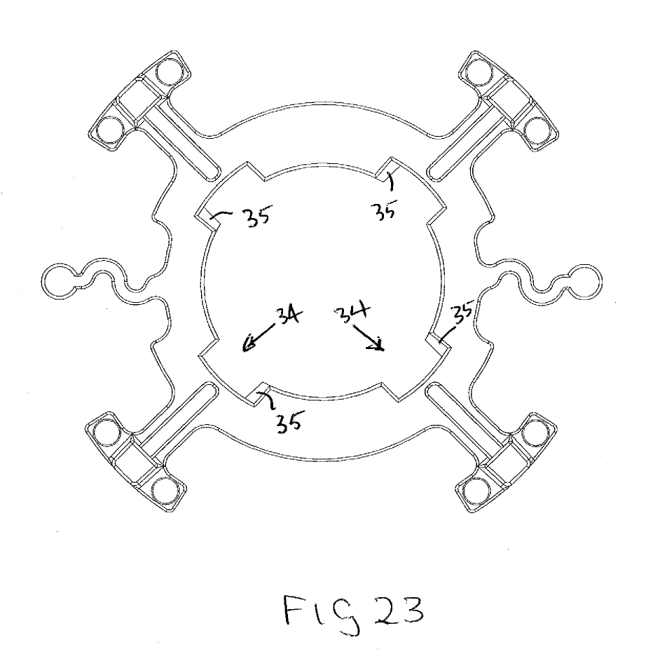

FIG. 23 is a view from above of the component of FIG. 22,

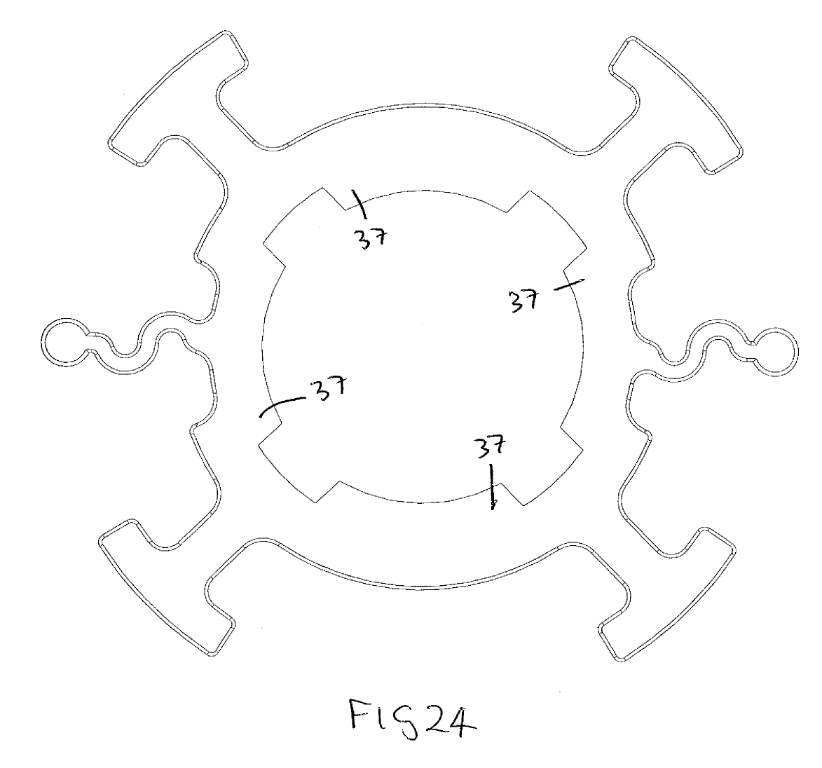

FIG. 24 is a view from below of the component shown in FIGS. 21 through 23,

FIG. 25 is the side elevational view of the component of FIGS. 21 to 24,

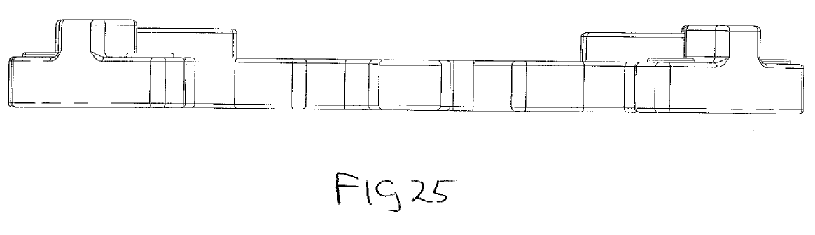

FIG. 26 is at least a sectioned view of the overall assembly showing the location, in plan, of the twist bias catch of FIGS. 21 through 25 when viewed downwardly towards the valves and the plateau of the housing,

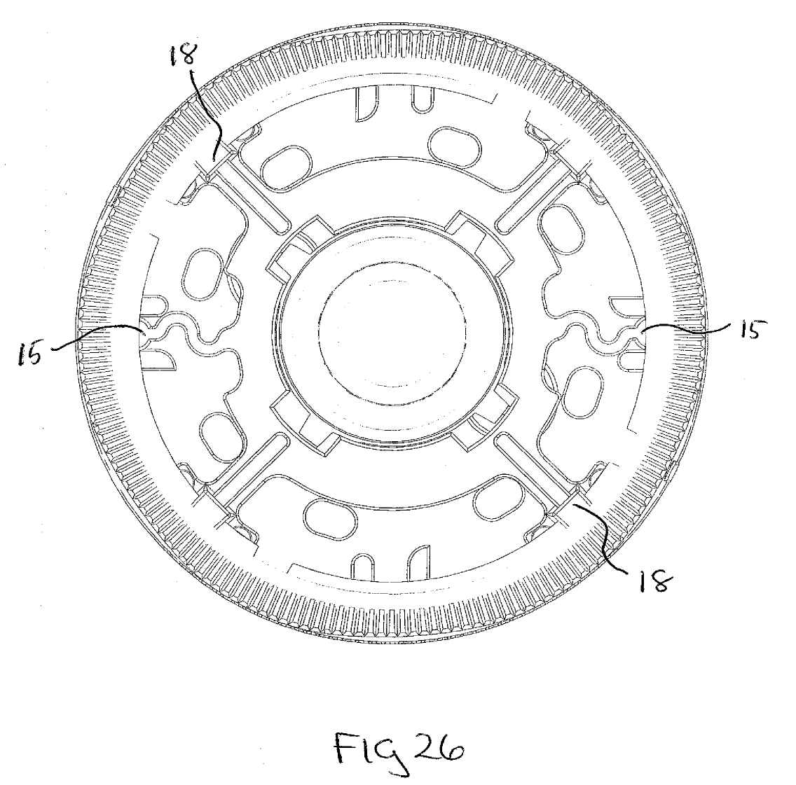

FIG. 27 is the reverse view to that described with respect to FIG. 26, ie, up to the twist top from below and a sectioned part of the nozzle complementary to the arrangement as shown in FIG. 26,

FIG. 28 is an isometric view from the insertable end of one of preferably two flexible valve members,

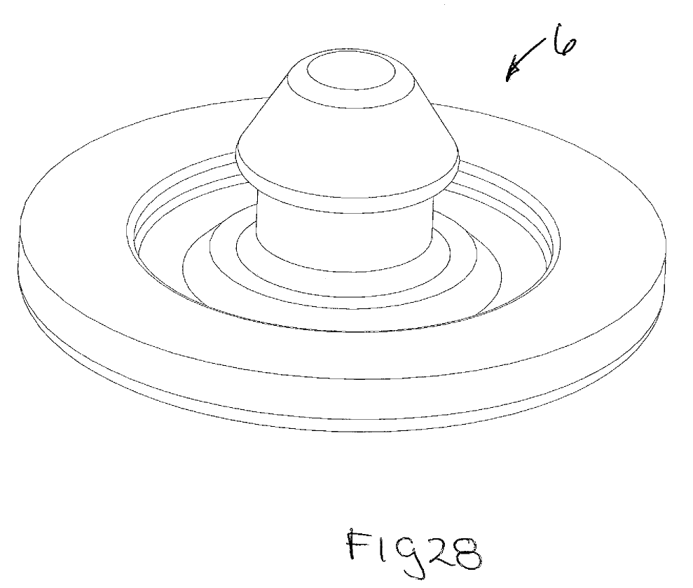

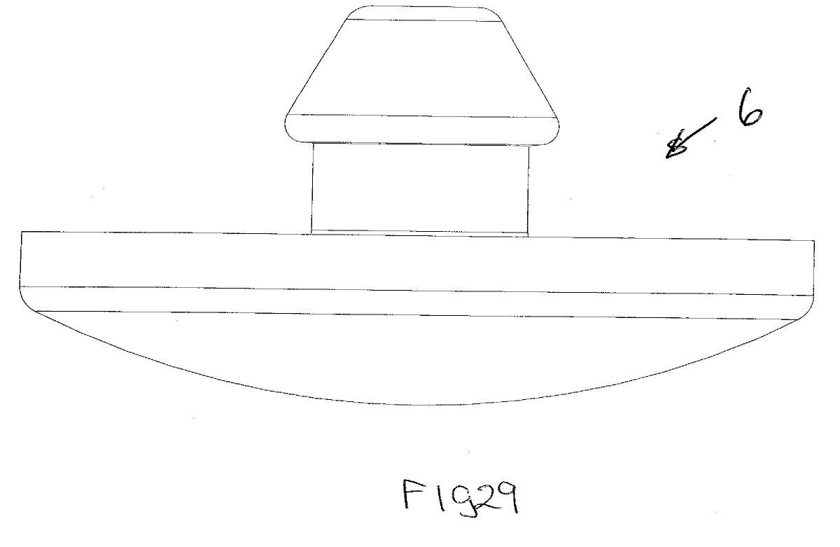

FIG. 29 is a side elevation of the flexible valve member of FIG. 28,

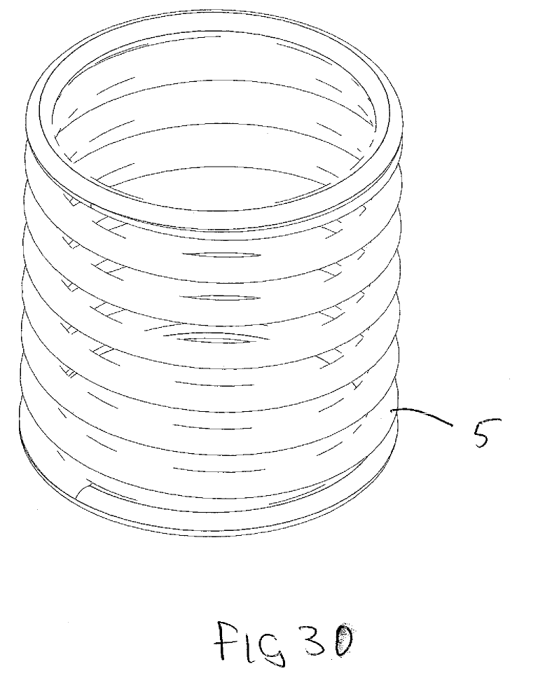

FIG. 30 is a top view of the valve member of FIG. 28 in plan,

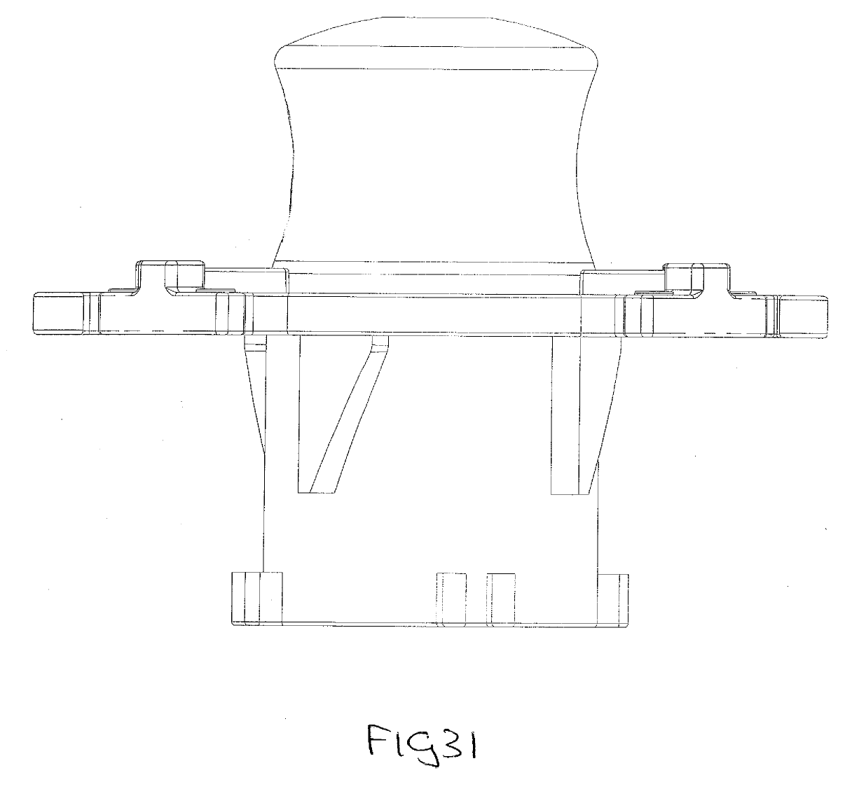

FIG. 31 shows in side elevation the relativity of the depressed nozzle of FIGS. 12 to 16 and the twist bias catch of FIGS. 21 to 25, the twist bias catch having been cammed to a return bias condition and then returned with that bias to its latching condition to prevent the nozzle from rising,

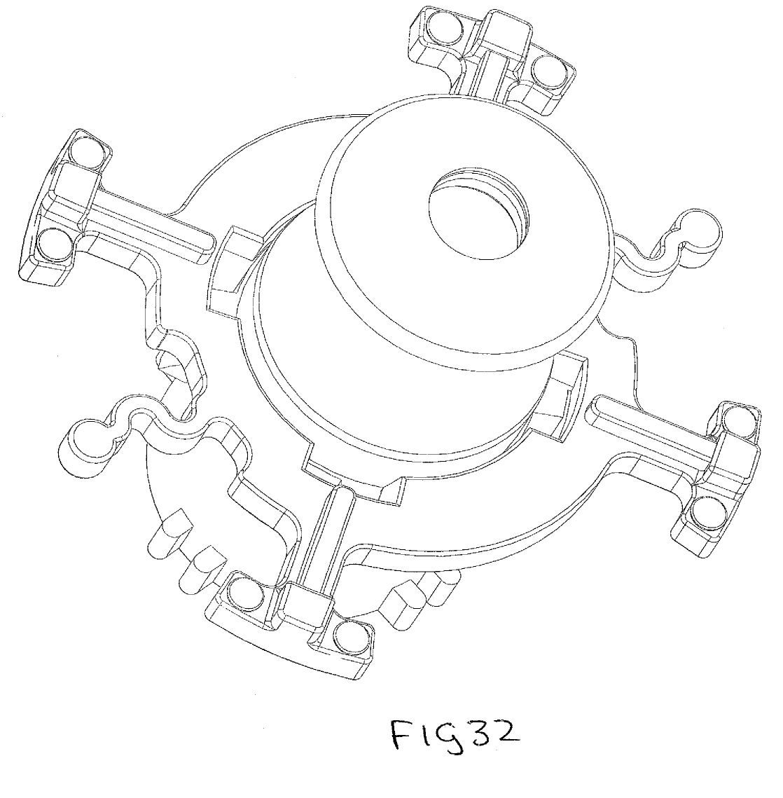

FIG. 32 is an isometric view from above of the arrangement of FIG. 31,

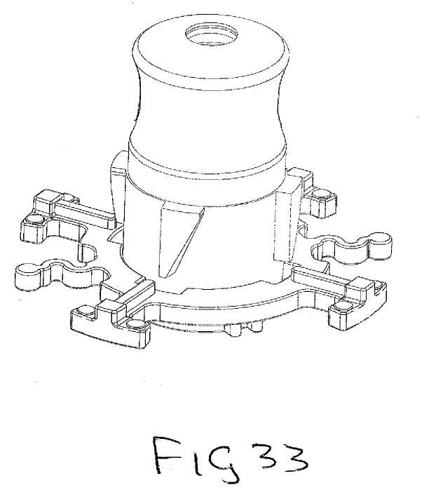

FIG. 33 is a similar view to that of FIG. 32 but showing the relativity when the nozzle is emergent (i.e. has been released,

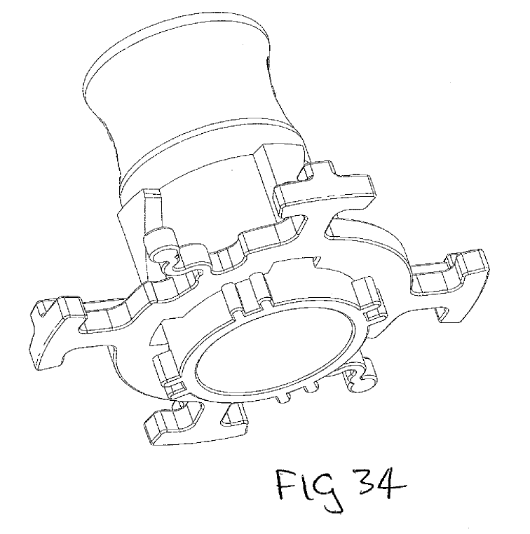

FIG. 34 is an isometric view from below of the arrangement of FIG. 33,

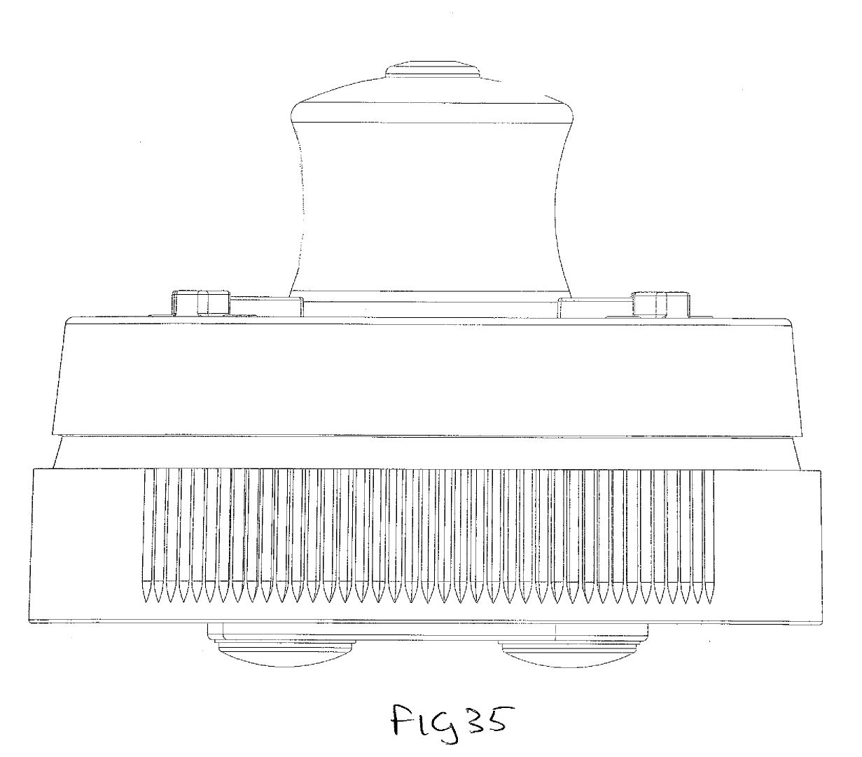

FIG. 35 is a side elevation of the assembly in the depressed and closed condition but not showing the turn top member of FIGS. 17 and 18,

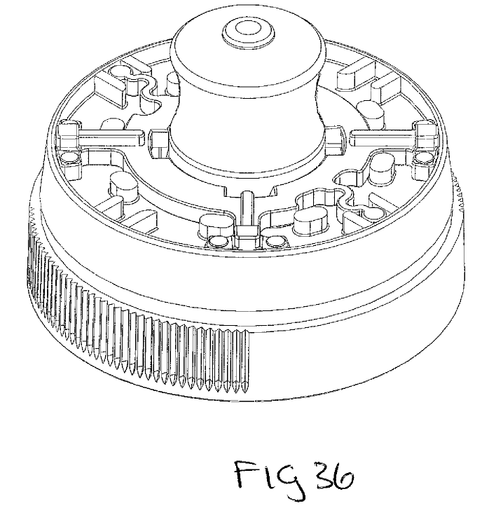

FIG. 36 is an isometric view from above of the arrangement of FIG. 35, the twist bias catch having returned from its previously cammed bias condition to its catch or latching condition,

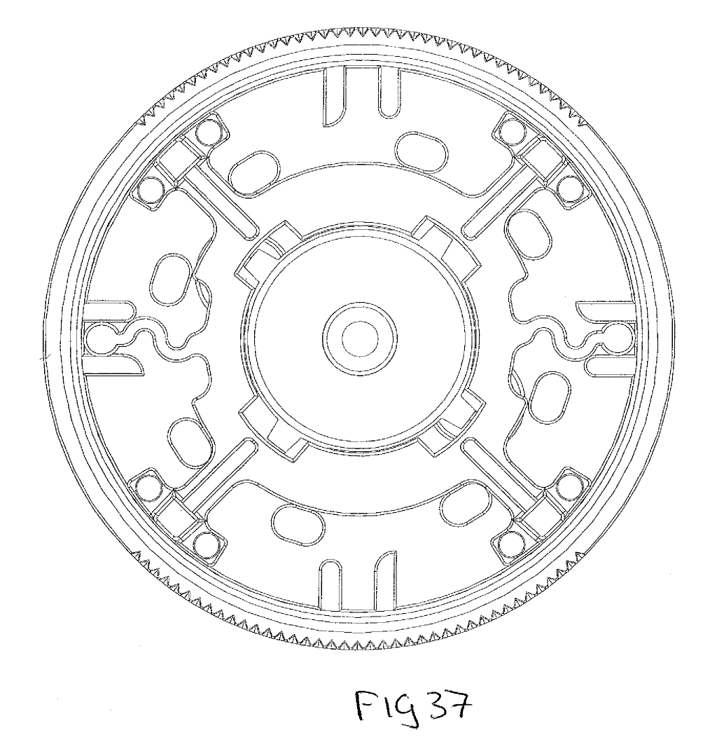

FIG. 37 is a plan view of the arrangement of FIGS. 35 and 36,

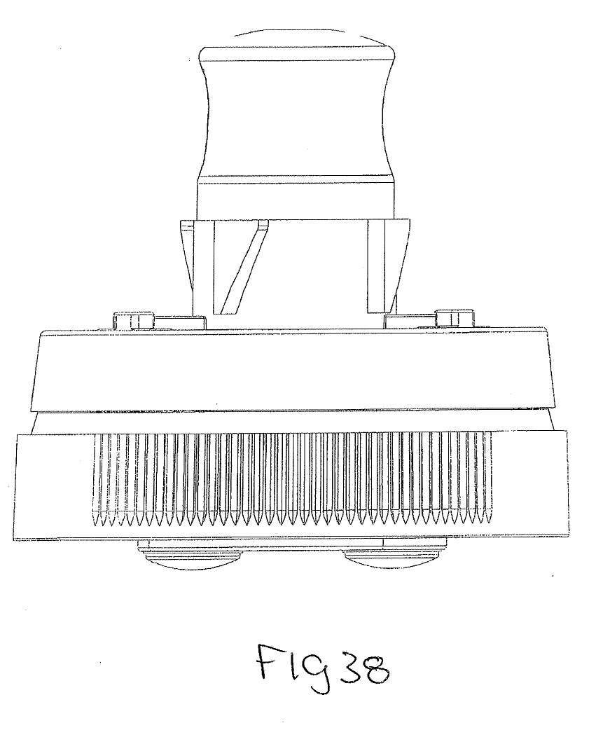

FIG. 38 is a similar view to that of FIG. 35 but with the nozzle emergent and no longer occluded (i.e. in the open condition),

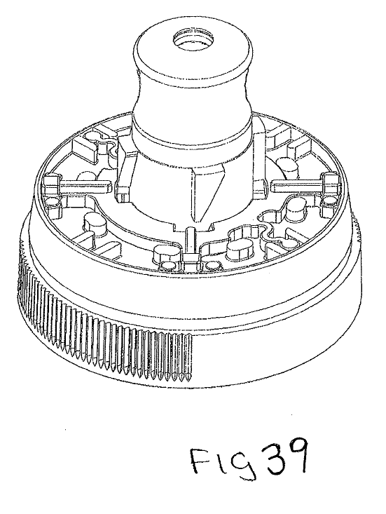

FIG. 39 is an isometric view from above showing the spring twist catch relaxed (and also as it would be in the latching condition were the nozzle depressed fully), the camming surfaces of the nozzle being able to interact, upon depressing the nozzle, to load up the bias of the spring twist catch (e.g. in part anticlockwise) and then upon full depression, to allow the spring twist catch to rotate clockwise under the bias to the catching or latching condition,

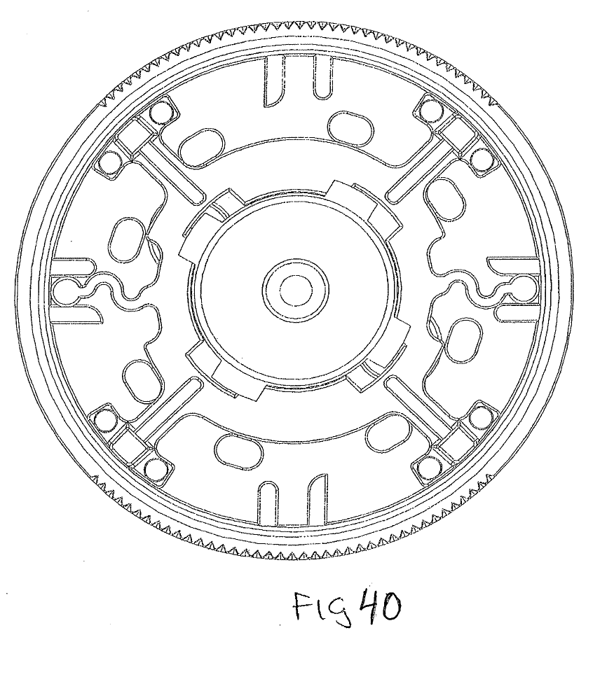

FIG. 40 is the plan view of the arrangement of FIGS. 38 and 39,

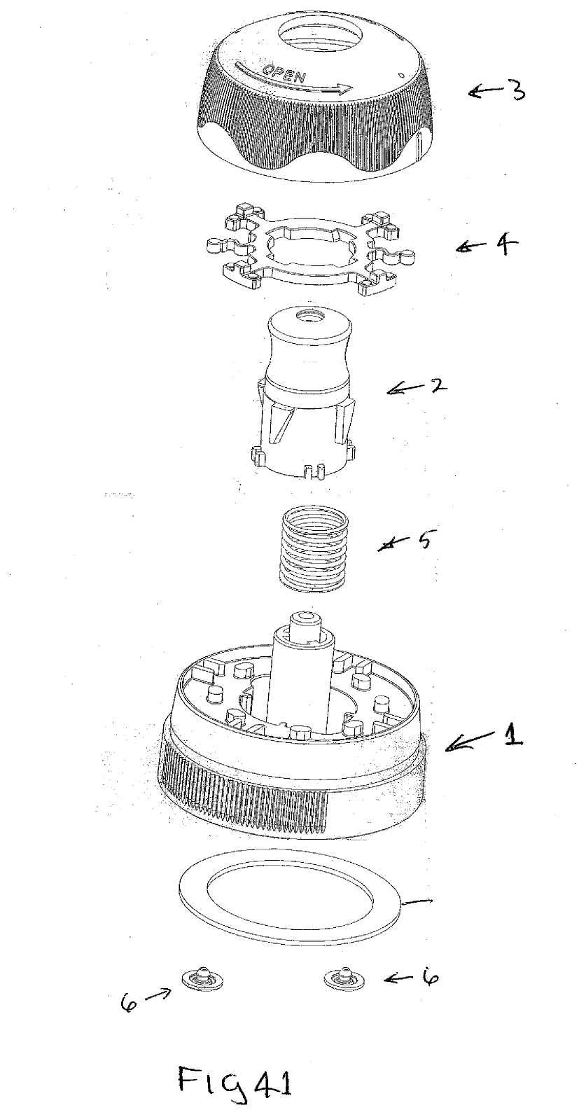

FIG. 41 is an exploded view showing the make-up of an assembly substantially as previously described, the view showing an annular seal to bed to the mouth of the container to which the assembly is to be fitted,

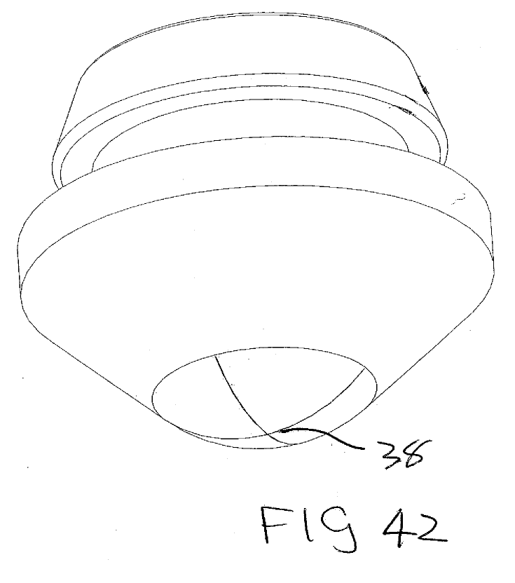

FIG. 42 shows, as an option, starburst or like split valving members able to substitute for the flexible valve of FIGS. 28 and 29, e.g. as might be used were the ports to be valved and with no bypass region flanking the inserted portion,

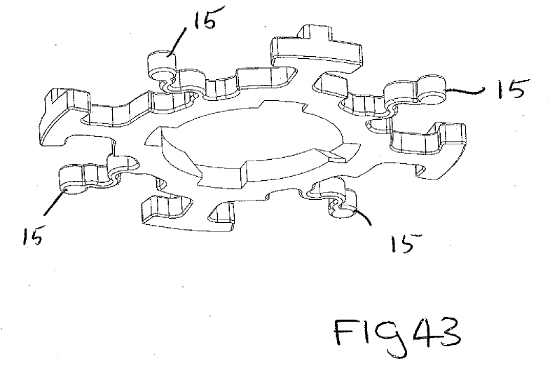

FIG. 43 shows a similar twist bias catch, but with four biasing and to be held outstands, and thus a stronger return bias.

A preferred embodiment of the present invention will now be described with reference to the accompanying drawings.

The components are as follows
a first moulded component or housing 1 as shown in at least FIG. 8,
a second moulded component or nozzle 2 as shown in at least FIG. 12,
a third component or turn top 3 as shown in at least FIG. 17,
a fourth moulded component or twist bias catch 4 (eg, of acetal) as shown in at least FIG. 22,
a spring 5 (eg, of SS) as shown in at least FIG. 11 and
two valving components 6 (e.g. of a food grade flexible rubber or synthetic rubber-like rubber) as shown in at least FIG. 28
an annular seal (e.g. of a food grade flexible rubber or synthetic rubber-like material).

Each of these components can be seen in the assembly drawings. The spring 5 (shown in some only of the assembly drawings) and the twist bias catch 4 can best be seen in some of the broken away sub-assembly drawings or the sectional views.

Preferably a plastics material is to be used for each moulded component.

Possible plastics can be selected from the group consisting of at least polypropylene (PP), polyethylene (PE), high density polyethylene (HDPE) and acetal. The seal and valving components can be of a food grade flexible natural or synthetic rubber-like material (e.g. silicone or other).

Each component can be injection moulded to shape in a number of different ways.

Each preferably requires a two part die and, depending on the form and the material, optionally inserts whereby a removal technique can be optimized for the two halves of the die.

A preferred choice of materials for this embodiment and indeed that described later are:
nozzle—HDPE
twist top or cover—PP
base housing—HDPE
twist bias catch—acetal
seal—synthetic rubber
valving members—synthetic rubber

There can be seen with respect to the housing 1 that there is a substantially cylindrical column 7 open at its bottom end for insertion into a container to which the interior thread of the skirt 8 is to be threaded to allow for a liquid flow pathway via opening 30. There is defined inwardly of an upstanding wall 9 and its inturned retention flange 10 a plateau 11 having upstands 12.

The retention flange 10 is to interact with the flange 32 of the turn top 3 in a click fit manner.

The upstands 12 are to act as stops for the amount of relative rotation permitted for the twist bias catch 4.

Receivable between the upstands 12 are the regions 16 of the member 4 so as to locate an arc of movement limited by the interaction of regions 16 and upstands 12. The peripherally slidable regions 17, each with an upstanding dog 18, is to have each dog 18 received within a recess 19 of the turn top 3.

Also inwardly extending from the wall of the housing are plural inward projections 13 each pairing to define a recess 14 into which an end region 15 of outward extensions of the twist bias catch 4 is to be received and held so as to ensure, in the assembled condition, there is a return bias for the remainder of the member 4 to its relaxed or more relaxed latching condition.

Defined at the top of the column 7 are outlets 20. The column integrally bridges to an occlusion region 21. This might be called a closure portion, an occlusion, an occluding member or the like.

The housing 1 has the annular well 22 surrounded by a cylindrical inwardly facing surface 23 from which there are defined guiding ribs 24 which, as male members, are to slidably receive the recesses 25 of the female member defined by outstands 26 of the nozzle member 2.

The bottom of the well 22 includes openings 27 into each of which a flexible valving member 6 is to be receivable in a click fit manner. This mushroom like insert 6 acts as a flutter valve for the passageways defined by the extension of the opening flanking the main part of each opening 27.

FIG. 10 best shows the opening 30 from below into the annular or substantially annular column 7.

FIG. 12 shows the occludable opening 31 of the nozzle member 2 which, in the condition as shown in FIG. 1A, is closed by the occlusion 21.

The twist bias catch 4 can be as shown or can be quite different in configuration. For example, if a stronger rotational bias is wanted, more biasing fingers to region 15 can be provided as shown in FIG. 43.

FIGS. 4A and 4B shows how the member 4 is interposed between members 1 and 3 and surrounds member 2. In the condition as shown in FIG. 4A the spring 5 (not shown) is shown compressed axially (yet substantially in the condition as shown in FIG. 4B). The spring 5 will have expanded from the condition (as shown) up more towards the underside of the surface 33 of the nozzle.

A feature of the present invention therefore, as is apparent from the attached drawings, is the “twist to open” capability (or twisting as one of several different interactions that are possible to provide a delatching of a closed nozzle assembly, the nozzle assembly opening under the action of a bias) and the ‘push’ close capability (or camming to create a bias return for a latching member to hold the nozzle down against its bias).

In the assembly

(a) the nozzle 2 cannot rotate relative to the housing 1 (i.e. because of the male/female sliding of each member 24 in a recess 25).

(b) The outstands 16 of spring return twist 4 dog the members 18 into recess 19 of turn top 3 and the ends 15 of the rotary bias providing outstands are held in spaces 14 against rotation with the turn top 3 and the remainder of the member 4.

(c) The profile features 28 of nozzle 2 provide a camming surface 29 to interact on one edge region 35 of each rebate 34 of the spring return twist 4 as the nozzle (controlled as in (a) above) is depressed against its spring to an abutment position. This loads up energy in the bias providing outstands of member 4. Consequentially, upon profiles passing completely below the member 4, member 4 relaxes to its latching condition with profile members 28 having shoulders 36 under the region 37 of member 4.

Features of the present invention and its operation is readily apparent from the description and drawings.

Alternatives about for options to the various components and their interactions. For example other means than that shown can be used to allow axial movement but no rotary movement of the nozzle relative to the housing. Other means can be used to interact each of the turn top and the base with the latching member and/or rotary biasing member (preferably in all options the one and the same i.e. both the latching member and the force provider to move the latching member from a delatched condition to a latching condition.

By way of example also, as shown in FIG. 42 inserts into a round port can allow the breathing desired. See the starburst feature 38 shown to allow a valved movement of gas.

A person skilled in the art will appreciate how a container such as disclosed lends itself for fitting to a complementary threaded neck of a container. It is believed that closure assemblies as described lend themselves readily to aluminum containers owing to the self venting feature after each dispensing of a liquid content of such a container.

1. A dispensing closure assembly having a dispensing nozzle able to be closed against a bias yet releasable so as to allow that bias to move it to an open and dispensing condition.

2. A dispensing closure assembly of a kind having an occludable nozzle able
to close a dispensing path way when the nozzle is in one condition relative to an occlusion providing member or assembly, and
to open a dispensing pathway when the nozzle is in a second condition relative to the occlusion providing member or assembly;
wherein the nozzle is movable from the non occluded open and dispensing condition to the occluded non-dispensing closed condition against a bias;
and wherein the nozzle is releasably latchable in the closed condition.

3. The assembly of claim 1 said nozzle is releasable by a twisting of one member of the dispensing closure assembly relative to another.

4. The assembly of claim 3 wherein said twisting is against a rotational bias.

5. The assembly of claim 1 wherein said nozzle moves rectilinearly against or with the bias and such bias is distinct.

6. A dispensing closure assembly suitable to be engaged to a complementary container, said assembly comprising or including
a first moulded component (“first component” or “housing”) adapted to engage an outlet of a complementary container and to provide a column with an outlet from which any liquid or other content (“liquid”) of such a container can egress, the first component including a closure portion or occlusion above said outlet, said column, in part, coaxially defining part of a surrounding annular well;
a second moulded component (“second component” or “nozzle”) coaxially about said column and sitting at least partially within the annular well, the second component having a dispensing outlet capable of being closed or occluded by the closure portion or occlusion of said first component, and the second component being able to move axially with respect to the column yet be restrained from rotation relative to the first component;
a spring or other biasing member (“spring”) disposed in the well of the first component and able to bias the second component to a non-occluded raised condition with respect to the first component;
a third moulded component (“third component” or “turn top”) held captive by said first component but rotatable relative thereto,
a fourth moulded component (“fourth component” or “twist bias catch”) about the nozzle and separately engaged to each of the first and third components so as to allow rotation or twisting of the third component relative to the first component yet to provide a return bias (“twist return bias”);
wherein the forth component and nozzle have profile features for a camming interaction to rotate in part the fourth component thereby to load up a twist return bias when the nozzle, when outstanding, is pressed against its spring towards its to be latched condition;
and wherein the forth component and nozzle enables, subsequent to the camming action that loads up the twist return bias, latching of part of the nozzle by the fourth component, as it is in part return rotated by the twist return bias.

7. The assembly of claim 6 wherein the first moulded component (by insert or inserts, or otherwise) provides for an air inbleed via the annular well at least during nozzle lowering.

8. The assembly of claim 6 wherein the first component or housing has within the well a male or female guide or guides for complementary female or male guide(s) of the second component or nozzle.

9. The assembly of claim 8 wherein the guide(s) are mouldable male outstands which are within short female channel profiles as outstands of the nozzle.

10. The assembly of claim 6 wherein said first component or housing is screw thread engageable to a complementary container.

11. The assembly of claim 6 wherein the annular well is a true annular well with inner and/or outer facing substantially circular sectioned surface(s).

12. The assembly of claim 6 wherein the column is substantially tubular and the other perimeter of the well is substantially circular.

13. The assembly of claim 6 wherein a plateau is defined about the annular well by said first moulded member.

14. The assembly of claim 13 wherein that plateau is bounded by an upstanding wall.

15. The assembly of claim 6 wherein there are plurality of profiles adapted to fix against rotation bias providing outstands of said fourth component or twist bias catch.

16. The assembly of claim 6 wherein there are provided a plurality of upstands from the plateau to act as stops to limit rotation of the twist bias catch relative to the housing.

17. The assembly of claim 6 wherein said fourth component or twist bias catch includes outward extending outstands to act as stops relative to upstands of the housing.

18. The assembly of claim 17 wherein those same outstands or other outstands provide a dog or other engagement feature to assume a non rotational engagement relative to said third moulded component or turn top ie, preferably dogs engageable into recesses of the third moulded component.

19. The assembly of claim 18 wherein, in addition to the outstand or outstands that provide the stop and/or provide dogging with respect to the turn top, there are outstands to provide the radial bias.

20. The assembly of claim 19 wherein the radial bias providing outstands are each engaged at their distal regions against rotation relative to the housing eg, preferably in said female profiles inwardly of the wall of the housing.

21. The assembly of claim 6 wherein the inner periphery of said fourth component or twist bias catch which is to surround the column and the nozzle includes one or more camming surfaces down to an abutment shoulder or abutment shoulders.

22. The assembly of claim 21 wherein said abutment shoulder(s) is part of the under surface of the fourth component.

23. The assembly of claim 6 wherein the fourth component or twist bias catch has any one or more of the features herein described.

24. The assembly of claim 6 wherein the nozzle has cammable or cam following surfaces to an abutment retention surface or each to an abutment retention surface (common or otherwise).

25. The assembly of claim 6 wherein the camming and latching is by a mechanism substantially as herein described by reference to any one or more of the accompanying drawings and/or substantially as herein described.

26. A dispensing closure assembly having a dispensing nozzle able to be closed and held in its closed condition against a rectilinear bias yet releasable from its held condition so as to allow the rectilinear bias to move the nozzle to its open condition;
wherein a resilient latching member provides the holding of the nozzle in the held and closed condition;
and wherein the resilient latching member has held outward extensions that provide a return bias of the remainder of the resilient latching member to its latching condition from cam rotated conditions during closure.

27. (canceled)

28. A dispending closure assembly having a dispensing nozzle able to be closed against a bias yet releasable so as to allow that bias to move it to an open and dispensing condition by a twist of one component relative to another;
wherein there is provided an air bleed valve arrangement communicable with the ambient air other than via the flow path for dispensable contents.

29. The assembly of claim 28 wherein the arrangement is substantially herein described irrespective of whether or not includes any one or more of the features of other aspects of the present invention.
